(19) United States
(12) Patent Application Publication
(10) Pub. No.: US 2026/0204104 A1
(43) Pub. Date: Jul. 16, 2026

(54) GEOLOCATION-BASED PREDICTIVE MAINTENANCE OF AIR FILTRATION

(71) Applicant: International Truck Intellectual Property Company, LLC, Lisle, IL (US)

(72) Inventors: Joshua David Manis, Carol Stream, IL (US); Kyle Patrick Hickey, Palatine, IL (US); Paul Boon Charintranond, Arlington Heights, IL (US)

(73) Assignee: International Truck Intellectual Property Company, LLC, Lisle, IL (US)

(21) Appl. No.: 19/014,320

(22) Filed: Jan. 9, 2025

(51) Int. Cl. G07C 5/00; G07C 5/08

(52) U.S. Cl. CPC G07C 5/006; G07C 5/008; G07C 5/0808; G07C 5/0825

(57) ABSTRACT

A vehicle includes an air-filter and an engine, the air-filter in fluid communication with the engine. The controller is configured to obtain a geographic location of the vehicle and at least one operating parameter of the engine at the geographic location; obtain an airborne particulate matter estimate based on the geographic location of the vehicle and the at least one operating parameter of the engine; and determine a remaining useful life of the air-filter based on the airborne particulate matter estimate.

### FIELD OF THE INVENTION

The present disclosure relates generally to vehicle air filtration maintenance, and more particularly to a system and method of geolocation-based predictive maintenance of air filtration.

### BACKGROUND

Current techniques for providing information about engine air filter service intervals include use of sensors. Sensors are installed near the air filter to measure the pressure drop (dP) across the air filter. Unfortunately, there are drawbacks with the use of sensors, such as, for example, limitations on sensor life, sensor malfunctions and the increased complication due to an increased number of additional components in a vehicle system. There is a need to provide improved techniques for air filtration maintenance.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 is a schematic diagram of a system according to an embodiment of the present disclosure;

FIG. 2 is a block diagram of the system according to another embodiment of the present disclosure;

FIG. 3 is a flowchart of a method according to an embodiment of the present disclosure; and

FIG. 4 is a flow diagram of the system according to yet another embodiment of the present disclosure.

In the following detailed description, various embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

As described above, there is a need to provide improved techniques for air filtration maintenance. The present disclosure provides an arrangement to improve the efficiency of air filtration predictive maintenance in vehicles. The present disclosure provides for a system and method in which particulate matter from vehicle emissions, loose material on the road surface, and other emitting sources can be estimated based on geographic location (geo-location) of the vehicle. Utilizing geo-location data residency, vehicle speed data and engine speed allows filter loading to be accurately estimated and utilized to predict the usefulness of the air filter based on a predetermined loading capacity of the air filter. This can simplify the remaining useful life (RUL) calculation by removing the system dynamics from the equation. Pressure drop measurements across an air filter are dependent on the mass air flow, engine speed, load, etc. which can be very complicated to calculate.

Accordingly, one aspect of the present disclosure provides for a vehicle having an air-filter, an engine and a controller configured to obtain a geographic location of the vehicle and at least one operating parameter of the engine at the geographic location. The controller is configured to obtain an airborne particulate matter estimate based on the geographic location of the vehicle and the at least one operating parameter of the engine; and determine a remaining useful life of the air-filter based on the airborne particulate matter estimate. By eliminating the need to use measurement sensors, air filtration predictive maintenance becomes more efficient.

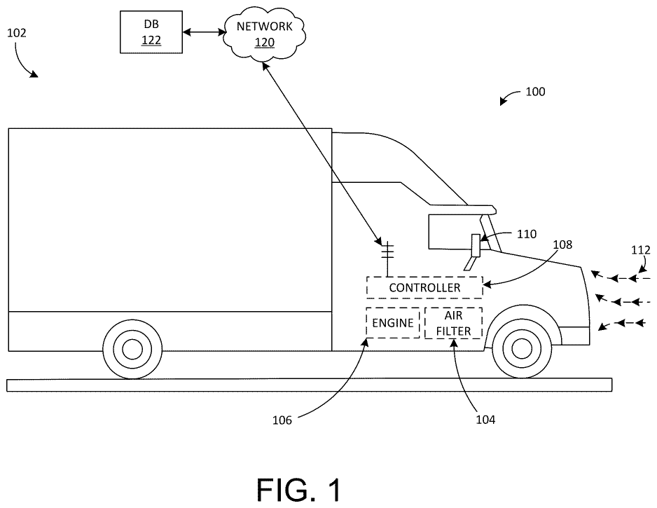

Referring to FIG. 1, an example vehicle air filtration maintenance system 100 is shown in a schematic diagram. The system 100 includes a vehicle 102, which has an air-filter 104, an engine 106 in fluid communication with the air-filter 104, an air-filter (AF) controller 108 and an in-vehicle display 110. The engine 106 is a combustion engine located near the front of the vehicle 102 under the hood, in an engine bay of the vehicle 102. Alternatively, the engine could be located in other areas of the vehicle, such as near the rear or side of the vehicle, as may be the case with some vehicles. As the engine 106 propels the vehicle 102 forward, airborne particulate matter 112 enters the vehicle 102 and travels to the air-filter 104 before reaching the engine 106. For example, cooler air from outside the vehicle may travel through tubing to the air-filter and then from the air-filter to an air intake manifold mounted to the engine. The air-filter 104 cleans the air before it enters the engine 106 protecting the engine cylinders from airborne particulate matter 112 that may damage the engine 106 or reduce engine efficiency. The air-filter 104 may be any type of known engine intake air filter. The air-filter 104 may be associated with a predetermined dust loading capacity (e.g., as determined by the manufacturer), which may be used to determine the RUL of the air-filter 104. The predetermined dust loading capacity may be stored in non-volatile memory of the AF controller 108.

The system 100 further includes a network 120 that connects the AF controller 108 on the vehicle 102 to a remote air quality (AQ) database 122. The network 120 is preferably a wide area network (WAN) (e.g., the Internet, cellular network, etc.) in order to allow the AF controller 108 on the vehicle 102 to access the AQ database 122 from any geographic location, over-the-air (OTA). The AQ database 122 stores historical data about the air quality at various geographic locations. The AQ database 122 may store air quality information as, for example, an air quality index (AQI), PM value or other like indication of air quality associated with each known geographic location. The AQ database 122 may be configured as a server computer, receiving client requests, and sending data in response to the requests.

By accessing the AQ database 122 from any geographic location at which the vehicle 102 may be driven, the AF controller 108 may receive an airborne particulate matter estimate from the AQ database 122 in real-time as the vehicle 102 is traveling. The AF controller 108 may obtain real-time location information (e.g., latitude and longitude coordinates) for the vehicle 102 and one or more engine operating parameters, such as speed, torque, power, ambient conditions, etc. and send such information to the AQ database 122 in order to receive the estimates. The engine operating parameters may be part of vehicle telematics data. The airborne particulate matter estimates received from the AQ database 122 are used by the AF controller 108 to periodically or continuously determine a real-time degradation of the air filter dust loading capacity of the air-filter 104 as the vehicle 102 is driven across multiple geographic locations over time. The degradation of the air filter dust loading capacity may be displayed on the in-vehicle display 110 to alert the driver as to when the air-filter 104 should be replaced. The in-vehicle display 110 may be any type of in-vehicle display used to show information about vehicle operation to a driver, such as an analog or digital gauge, a monitor, a touchscreen monitor, or the like.

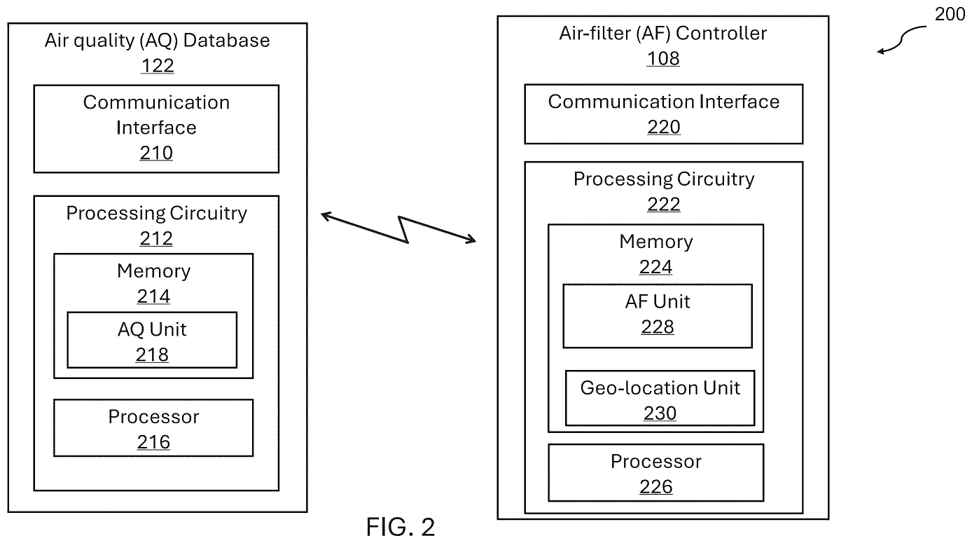

Referring to FIG. 2, one example implementation of the AF controller 108 and the AQ database 122 is shown in a block diagram of a system 200. The AQ database 122 includes a communication interface 210 and processing circuitry 212. The communication interface 210 is configured to set up and maintain a wired or wireless connection with an interface of a different communication device of the system 200, such as the AF controller 108. The communication interface 210 may include a radio interface for setting up and maintaining a wireless connection to the AF controller 108, such as one or more radio frequency (RF) transmitters, receivers, or transceivers. The processing circuitry 212 includes memory 214 and one or more processors 216. The processing circuitry 212 and/or processors 216 may be, for example, a central processing unit (CPU), field programmable gate away (FPGA), application-specific integrated circuitry (ASIC) and the like. The memory 214 may include any kind of volatile and/or nonvolatile memory, e.g., cache, buffer memory, random access memory (RAM), read only memory (ROM) and the like. The memory 214 includes an air-quality (AQ) unit 218 which has computer instructions that, when executed by the processor 216, causes the processor 216 to perform the methods and techniques described herein.

The AQ unit 218 has computer instructions to cause the processor 216 receive, via the communication interface 210, a geographic location of the vehicle 102 and at least one operating parameter of the engine 106 at the geographic location; and send, via the communication interface 210, an airborne particulate matter estimate based on the geographic location of the vehicle 102 and the at least one operating parameter of the engine 103.

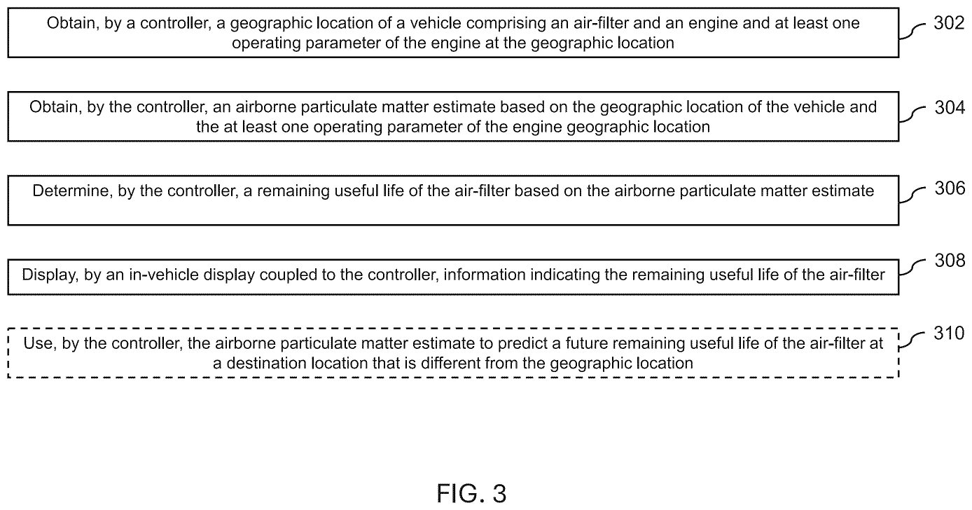

Referring to FIG. 2, the AF controller 108 includes a communication interface 220 and processing circuitry 222. The communication interface 220 is configured to set up and maintain a wired or wireless connection with an interface of a different communication device of the system 200, such as the AQ database 122. The communication interface 220 may include a radio interface for setting up and maintaining a wireless connection to the AQ database 122, such as one or more radio frequency (RF) transmitters, receivers, or transceivers. The processing circuitry 222 includes memory 224 and one or more processors 226. The processing circuitry 222 and/or processors 226 may be, for example, a central processing unit (CPU), field programmable gate away (FPGA), application-specific integrated circuitry (ASIC) and the like. The memory 224 may include any kind of volatile and/or nonvolatile memory, e.g., cache, buffer memory, random access memory (RAM), read only memory (ROM) and the like. The memory 224 includes an air-filter (AF) unit 228 which has computer instructions that, when executed by the processor 226, causes the processor 226 to perform the methods and techniques described herein, such as the method shown in the flowchart of FIG. 3.

Referring to FIGS. 2 and 3, the AF unit 218 has computer instructions to cause the processor 226 to obtain a geographic location of the vehicle 102 having an air-filter 104 in fluid communication with an engine 106 and at least one operating parameter of the engine 106 at the geographic location (S302); obtain an airborne particulate matter estimate based on the geographic location of the vehicle 102 and the at least one operating parameter of the engine 106 (S304); determine a remaining useful life of the air-filter 104 based on the airborne particulate matter estimate (306); and display, at an in-vehicle display 110 coupled to the AF controller 108, information indicating the remaining useful life of the air-filter 104 (308).

The AF unit 218 has computer instructions to cause the processor 226 to obtain vehicle telematics data including latitude and longitude coordinates indicating the geographic location of the vehicle 102 (i.e., GPS coordinates) and the vehicle telematics data further including at least one of an engine speed, engine torque and an engine power at which the engine 106 is operating at the geographic location. The AF unit 218 has computer instructions to cause the processor 226 to obtain the vehicle telematics data including ambient conditions of the vehicle 102 at the geographic location, wherein the airborne particulate matter estimate is based on the latitude and longitude coordinates, the at least one of the engine speed, the engine torque and the engine power and the ambient conditions. The AF unit 218 has computer instructions to cause the processor 226 to send, via the communication interface 220, the geographic location of the vehicle 102 and the at least one operating parameter of the engine 106 to the remote AQ database 122; and receive, via the communication interface 220, the airborne particulate matter estimate in response to the sending.

The AF unit 218 has computer instructions to cause the processor 226 to determine a degradation of a filter dust loading capacity of the air-filter 104 based on the airborne particulate matter estimate. In some embodiments, the AF unit 218 has computer instructions to cause the processor 226 to use the airborne particulate matter estimate to predict a future remaining useful life of the air-filter 104 at a destination location that is different from the geographic location (S310).

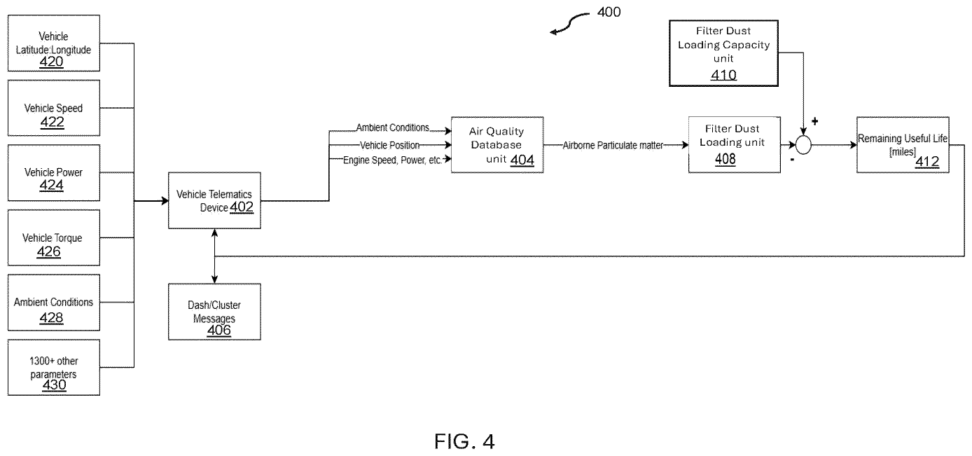

Referring to FIG. 4, an example system 400 for determining air-filter degradation based on geographic location according to the present disclosure is shown in a flow diagram. The system 400 includes a vehicle telematics device 402. The vehicle telematics device 402 receives and sends dash/cluster message 404. The vehicle telematics device 402 is configured to receive vehicle operation parameters including vehicle latitude and longitude coordinates 420, vehicle speed 422, vehicle power 242, vehicle torque 426, ambident conditions 428 and a multitude of other vehicle parameters 430. The vehicle telematics device 402 sends vehicle parameters, such as one or more of: ambient conditions 428, vehicle position 420, engine speed 422 and engine power 242 to an air quality database unit 404. The air quality database unit 404 may be configured to format and/or process the data received from the vehicle telematics device 402 so that such data can be sent to the AQ database 122. The air quality database unit 404 may also format and/or process the data received from the AQ database 122 so that such data can be used by the AF controller 108 to determine the RUL of the air-filter 104.

The filter dust loading capacity unit 410 stores information about the predetermined dust loading capacity (e.g., as determined by the manufacturer) of the air-filter 104. The filter dust loading unit 408 receives the airborne particulate matter estimate and uses such information to determine a degradation of the filter dust loading capacity of the air-filter 104 (e.g., by subtracting the dust load corresponding to the airborne particulate matter estimate from the dust loading capacity to determine the remaining useful life 412 of the air filter, which may be represented in miles left). In other embodiments, the remaining useful life 412 of the air filter may be determined in other ways and may be represented in other measurement units. The filter dust loading capacity unit 410, the filter dust loading unit 408 and the air quality database unit 404 may be included in the AF controller 108.

### INDUSTRIAL APPLICABILITY

A vehicle air filtration maintenance system is disclosed including an air-filter configured to filter intake air of an engine; and a controller configured to: obtain a geographic location of a vehicle and at least one operating parameter of the engine at the geographic location; obtain an airborne particulate matter estimate based on the geographic location of the vehicle and the at least one operating parameter of the engine; and determine a remaining useful life of the air-filter based on the airborne particulate matter estimate. The system can be manufactured in industry for use on vehicles purchased by consumers.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

What is claimed is:

1. A vehicle comprising:
an air-filter and an engine, the air-filter in fluid communication with the engine; and
a controller configured to:
obtain a geographic location of the vehicle and at least one operating parameter of the engine at the geographic location;
obtain an airborne particulate matter estimate based on the geographic location of the vehicle and the at least one operating parameter of the engine; and
determine a remaining useful life of the air-filter based on the airborne particulate matter estimate.

2. The vehicle of claim 1, wherein the controller is configured to obtain the geographic location of the vehicle and the at least one operating parameter by being configured to:
obtain vehicle telematics data including latitude and longitude coordinates indicating the geographic location of the vehicle and further including at least one of an engine speed, engine torque and an engine power at which the engine is operating at the geographic location.

3. The vehicle of claim 2, wherein the controller is configured to obtain the geographic location of the vehicle and the at least one operating parameter by being configured to:
obtain the vehicle telematics data including ambient conditions of the vehicle at the geographic location, wherein the airborne particulate matter estimate is based on the latitude and longitude coordinates, the at least one of the engine speed, the engine torque and the engine power and the ambient conditions.

4. The vehicle of claim 1, wherein the controller is configured to obtain the airborne particulate matter estimate by being configured to:
send the geographic location of the vehicle and the at least one operating parameter of the engine to a remote air quality database; and
receive the airborne particulate matter estimate in response to the sending.

5. The vehicle of claim 1, wherein the controller is configured to determine the remaining useful life of the air-filter by being configured to:
determine a degradation of a filter dust loading capacity of the air-filter based on the airborne particulate matter estimate.

6. The vehicle of claim 1, wherein the controller is further configured to:
use the airborne particulate matter estimate to predict a future remaining useful life of the air-filter at a destination location that is different from the geographic location.

7. The vehicle of claim 1, further comprising:
an in-vehicle display coupled to the controller, the controller being configured to cause the in-vehicle display to display information indicating the remaining useful life of the air-filter.

8. A method for vehicle air filtration maintenance comprising:
obtaining, by a controller, a geographic location of a vehicle comprising an air-filter in fluid communication with an engine and at least one operating parameter of the engine at the geographic location;
obtaining, by the controller, an airborne particulate matter estimate based on the geographic location of the vehicle and the at least one operating parameter of the engine;
determining, by the controller, a remaining useful life of the air-filter based on the airborne particulate matter estimate; and
displaying, by an in-vehicle display coupled to the controller, information indicating the remaining useful life of the air-filter.

9. The method of claim 8, wherein the obtaining the geographic location of the vehicle and the at least one operating parameter of the engine comprises:
obtaining vehicle telematics data including latitude and longitude coordinates indicating the geographic location of the vehicle and further including at least one of an engine speed, engine torque and an engine power at which the engine is operating at the geographic location.

10. The method of claim 9, wherein the obtaining the geographic location of the vehicle and the at least one operating parameter of the engine further comprises:
obtaining the vehicle telematics data including ambient conditions of the vehicle at the geographic location, wherein the airborne particulate matter estimate is based on the latitude and longitude coordinates, the at least one of the engine speed, the engine torque and the engine power and the ambient conditions.

11. The method of claim 8, wherein the obtaining the airborne particulate matter estimate comprises:
sending the geographic location of the vehicle and the at least one operating parameter of the engine to a remote air quality database; and
receiving the airborne particulate matter estimate in response to the sending.

12. The method of claim 8, wherein the determining the remaining useful life of the air-filter based on the airborne particulate matter estimate comprises:
determining a degradation of a filter dust loading capacity of the air-filter based on the airborne particulate matter estimate.

13. The method of claim 8, further comprising:
using, by the controller, the airborne particulate matter estimate to predict a future remaining useful life of the air-filter at a destination location that is different from the geographic location.

14. A vehicle air filtration maintenance system comprising:
an air-filter configured to filter intake air of an engine; and
a controller configured to:
obtain a geographic location of a vehicle and at least one operating parameter of the engine at the geographic location;
obtain an airborne particulate matter estimate based on the geographic location of the vehicle and the at least one operating parameter of the engine; and
determine a remaining useful life of the air-filter based on the airborne particulate matter estimate.

15. The vehicle air filtration maintenance system of claim 14, wherein the controller is configured to obtain the geographic location of the vehicle and the at least one operating parameter by being configured to:
obtain vehicle telematics data including latitude and longitude coordinates indicating the geographic location of the vehicle and further including at least one of an engine speed, engine torque and an engine power at which the engine is operating at the geographic location.

16. The vehicle air filtration maintenance system of claim 15, wherein the controller is configured to obtain the geographic location of the vehicle and the at least one operating parameter by being configured to:
obtain the vehicle telematics data including ambient conditions of the vehicle at the geographic location, wherein the airborne particulate matter estimate is based on the latitude and longitude coordinates, the at least one of the engine speed, the engine torque and the engine power and the ambient conditions.

17. The vehicle air filtration maintenance system of claim 14, wherein the controller is configured to obtain the airborne particulate matter estimate by being configured to:
send the geographic location of the vehicle and the at least one operating parameter of the engine to a remote air quality database; and
receive the airborne particulate matter estimate in response to the sending.

18. The vehicle air filtration maintenance system of claim 14, wherein the controller is configured to determine the remaining useful life of the air-filter by being configured to:
determine a degradation of a filter dust loading capacity of the air-filter based on the airborne particulate matter estimate.

19. The vehicle air filtration maintenance system of claim 14, wherein the controller is further configured to:
use the airborne particulate matter estimate to predict a future remaining useful life of the air-filter at a destination location that is different from the geographic location.

20. The vehicle air filtration maintenance system of claim 14, further comprising:
an in-vehicle display coupled to the controller, the controller being configured to cause the in-vehicle display to display information indicating the remaining useful life of the air-filter.
